(19) United States
(12) Patent Application Publication
(10) Pub. No.: US 2010/0160624 A1
(43) Pub. Date: Jun. 24, 2010

(54) Process for Producing High-Purity Sucrose

(75) Inventor: Mary Lou Cunningham, Missouri City, TX (US)

Correspondence Address: LOCKE LORD BISSELL & LIDDELL LLP;ATTN: IP DOCKETING, 600 TRAVIS, SUITE 3400, HOUSTON, TX, 77002-3095, US

(73) Assignee: Ragus Holdings, Inc., Sugar Land, TX (US)

(21) Appl. No.: 12/340,712

(22) Filed: Dec. 20, 2008

(51) Int. Cl. C13J 1/06; C13K 13/00

(52) U.S. Cl. 536/123.13; 127/46.2

(57) ABSTRACT

Improved processes for the purification of raw or refined sugar, or sucrose, to produce sucrose and sucrose-related products having substantially no inorganic impurities are described, wherein the processes include the use of both cation and anion exchange resins. In accordance with the process, a sucrose starting material, such as refined sugar or invert syrup, is dissolved in water at a temperature sufficient to dissolve the sucrose product and produce a low visicosity sucrose solution having not more than about 76 wt. % solids. Thereafter, the process includes contacting the low viscosity sucrose solution with one or more ion exchange resin beds, which can be separate or mixed, for a time sufficient to yield a highly-purified sucrose product that is substantially free of inorganic elemental impurities.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to processes for purifying sugar and sugar solutions, and more specifically are related to processes for producing high purity sucrose with low impurity levels using ion-exchange technology.

Description of the Related Art

The use and development of sugar has been traced back for thousands of years, and some reports have put the introduction of crude sugar into China from India at around 800 B.C. [Arthur C. Barnes, “The Sugar Cane, 2^{nd} Ed.,”, Aylesbury: L. Hill, 1974: page 1; Irvine, Sugar Journal, Vol. 43(9), 22 (1981)]. Since then, methods for processing raw sugar (such as from the sugarcane plant of the genus Saccarum) into a more pure form have continued to develop and evolve, as described in detail by Noel Deerr [in “The History of Sugar, Vol. II”, Chapman & Hall, London (1950)]. The standard method currently used to refine, for example, raw sugar to levels acceptable for marketing as white sugar and/or use in food products is through recrystallization methods and techniques. Typically, raw sugar includes sugar in crystalline form produced from sugar cane, and may be in a moist or in a liquid form where taken from a refining process prior to crystallization or in liquid form by dissolving raw sugar in crystalline form in water. This raw sugar is what is commonly purified prior to use.

In example only, a typical process is as follows. A common source of sugar is sugar cane. Sugar cane is harvested, and is then sent in cane form to a raw sugar mill. The sugar cane is processed at the mill in a shredder to break apart the cane and rupture juice cells. Rollers then extract sugar juice (also referred to as raw sugar) from the fibrous material, typically referred to as bagasse. The bagasse may be recycled as a fuel for the mill boiler furnaces, or can be used as a raw materials source for the production of chemicals such as furfural and ethanol. More recently, the bagasse has been used in the production of fibrous materials such as wood products and paper, and as animal feedstuffs. In addition to sucrose, raw sugar at this stage typically includes invert sugars, polysaccharides, ash (inorganic impurities), and other compounds, and has a color in the range of 1,000 to 5,000 IU. It is generally light brown in appearance. This raw sugar is later refined, usually at an off-site refinery, as described in more detail below.

Once it has been separated from the cane, the sugar juice is typically purified prior to concentration by boiling it in an evaporator. The concentrated juice or syrup is then concentrated further and seeded with small sugar crystals in an initial crystallization process. Sugar crystals are grown to a required size by adding syrup during boiling, as appropriate. A syrup is separated from these raw sugar crystals in centrifuges, and a molasses is typically left over from the final centrifuging. This raw sugar from the centrifuges is typically dried and transferred for storage.

A current practice of certain industrial scale food and/or beverage producers that utilize sugar is, for economic reasons, to purchase a high purity sugar product on the market from time to time that is in a form not yet suitable for use in food production, because such sugar product, e.g., contains impurities such as color and ash components. Such producers, while saving cost in purchasing such sugar for food and/or beverage production, usually also desire a whiter appearing sugar for their use in food and/or beverage production. Raw sugar, for example, while substantially pure in sucrose, typically is not considered fit for direct use as food or a food ingredient due to the impurities it ordinarily contains. As stated, high purity sucrose material such as raw sugar currently has been purified by non-chromatographic processes such as a process utilizing affination in which raw sugar is mixed with hot concentrated syrup to soften outer coating crystals, which are then separated from syrup by centrifugation. Crystals are discharged from the centrifuge and dissolved in hot water to form a sugar liquor.

The melted sugar liquor is purified with either a carbonation or phosphatation process which traps suspended impurities in larger particles that are easier to separate from the sugar liquor. Carbonatation adds carbon dioxide and lime to melted sugar to form a precipitate of calcium carbonate. Carbonatation precipitate is removed, for instance, by pressure filtering sugar liquor through cloth in a pressure leaf filter, leaving a straw-colored, crystal clear liquid. Phosphatation adds phosphoric acid to melted sugar and removes precipitate as a layer from a flotation clarifier. Phosphatated liquor is generally filtered through sand in a deep bed filter to remove residual precipitate left after clarification. This liquid then passes through decolorizing columns which adsorb the colorant molecules. A clear liquid is concentrated by boiling in a vacuum pan, and then seeded with fine sugar crystals and grown to a desired size by adding liquor. When crystals are a desired size, crystals and syrup are discharged from the pan. The mixture of crystals and syrup is processed in centrifuges where crystals are separated from syrup. Separated syrup is boiled again and more sugar crystals are extracted from it, and repeated. Refined sugar crystals are dried by tumbling them through a stream of air, then graded and packaged. Other purification methods include sulfitation processes and decolorizing processes known as the Talofloc, Talodura (GB 1,428,790 and GB 1,397,927), and SURE processes [SIT, Frank, et al., 1986, pp. 64-96] which use quaternary ammonium compounds or polyacrylaimides (Talofloc, SURE) or phosphoric acid, lime, and a polymer flocculant in a “phosflotation” process (Talodura process) for color removal, wherein negative-charged color bodies are reacted with the positive-charged hydrophobic molecules to form flocculates which float to the top of the solution, allowing for the removal of the color impurities from sugar solutions by skimming the floating flocculates away [see, “Cane Sugar Handbook: A Manual for Cane Sugar Manufacturers and Their Chemists, 12^{th} Edition”, by Chung-Chi Chou, John Wiley & Sons, 1993]. A number of other purification processes for raw sugar production, developed for a variety of reasons, have been reported over the years.

For example, U.S. Pat. No. 4,412,866 describes an example of the operation of chromatographic simulated moving bed (or sometimes called “SMB”) method to separate the components of a raw sugar feed stock. According to the patent, a resin bed is divided into a series of discrete vessels, each of which functions as a zone within a circulation loop. A manifold system connects the vessels and directs, in appropriate sequence to (or from) each vessel, each of the four media accommodated by the process. Those media are generally referred to as feed stock, eluent, extract and raffinate, respectively. As defined in the patent, a typical feed stock is a lower purity sucrose solution, the eluent is water, the extract is an aqueous solution of sucrose, and the raffinate is an aqueous solution containing nonsucrose components, such as salts and high molecular weight compounds. The simulated moving bed disclosed by the '866 patent is of the type sometimes referred to as a “continuous SMB.”

In U.S. Pat. No. 5,454,952, a method of removing ash from sugar-containing solutions is described which “comprises contacting the sugar containing solution against one side of an ultrafiltration membrane with a stripping fluid to strip away monovalent ions and low molecular weight sugars which pass through the membrane. The stripping fluid is contacted at high pressure against one side of a nanofiltration membrane which allows passage of monovalent ions and water only. The deashed retentate can be returned to sugar containing solution, pass through an ion exchange column or cause to contact one side of a high pressure ultrafiltration membrane which allows passage of water monovalent ions and low molecular weight sugars. The permeate from the high pressure ultrafiltration membrane can be subjected to ion exchange to provide a liquid sugar having a low ash content while the retentate can be evaporated to a sugar product”. The use of the semipermeable membranes reportedly allows efficient deashing of sugar containing solutions (i.e. sugar cane or sugar beet solutions) which improves the recovery of crystalline sugar and a quality of the sugar from the solution.

More recently, a method of purifying a sucrose material already in a high-purity liquid, crystalline or other sucrose form has been described in U.S. Pat. No. 7,125,455, wherein the process utilizes chromatography alone or in combination with other methods of purification, so as to provide a product stream with a color rating of less than 200 on a United States ICUMSA scale. A number of other approaches to purifying sucrose have been suggested, such as membrane filtration processes as described in U.S. Pat. No. 6,440,222; chromatographic separation processes such as described in U.S. Pat. Nos. 7,229,558 and 6,482,323; and nanofiltration process applications, such as described in U.S. Pat. No. 7,008,485.

Despite the advances that have been made in sucrose processing, many of the methods suggested above, along with chemical precipitation and/or carbon absorption, are considered to be relatively expense to implement, and sometimes more ‘experimental’ or ‘less practiced’ methods due to the economics involved of including such expensive and oftentimes complex systems into a purification process that generates a low-cost end product. For example, with reference to filtration and nanofiltration purification methods, the flow through the membranes is typically slow because of the small pore size, requiring large membrane surfaces and significant pumping pressures, which in turn lead to increased capital requirements and operating costs. The inventions disclosed and taught herein are directed to processes for the preparation of high purity sucrose and sucrose-related products which are capable of implementation into a sugar processing plant in large scale, and which provide a sucrose product which is substantially free of inorganic impurities.

### BRIEF SUMMARY OF THE INVENTION

Processes for the production of highly-purified sucrose and sucrose-related products are described herein, wherein the highly-purified products are substantially free of inorganic elemental impurities. In accordance with one aspect of the present disclosure, a process for manufacturing purified sucrose is described, wherein the process comprises obtaining a sucrose feed material, contacting the sucrose feed material with water at a temperature sufficient to dissolve the sucrose feed material and produce a low viscosity sucrose solution having not more than about 76 wt. % solids; contacting the low viscosity sucrose solution with a first ion exchange resin; and contacting the low viscosity sucrose solution with a second ion exchange resin; wherein the purified sucrose eluted from the ion exchange columns is substantially free of inorganic impurities, and optionally has a color of 46 RBU or less. In accordance with this aspect of the disclosure, the sucrose feed material may be in solid form, such as a granulated sugar product, or may an invert syrup. In further accordance with this and other aspects of the present disclosure, the low viscosity sucrose solution has a viscosity ranging from about 10 cPs to about 70 cPs.

In accordance with a further aspect of the present disclosure, a process for manufacturing highly-purified sucrose is described, wherein the process comprises a process for manufacturing purified sucrose is described, wherein the process comprises obtaining a sucrose feed material, contacting the sucrose feed material with water at a temperature sufficient to dissolve the sucrose feed material and produce a low viscosity sucrose solution having not more than about 76 wt. % solids; contacting the low viscosity sucrose solution with a first ion exchange resin bed in cation form by pumping the low viscosity sucrose solution through the first resin bed; contacting the low viscosity sucrose solution with a second ion exchange resin bed in anion form by pumping the low viscosity sucrose solution through the second resin bed; and spectroscopically analyzing the sucrose solution as it is eluted out of the second resin bed, wherein the purified sucrose eluted from the ion exchange columns contains less than about 0.1 ppm aluminum, less than about 0.1 ppm boron, and less than about 0.1 ppm phosphorus. In accordance with this aspect of the disclosure, the sucrose feed material may be in solid form, such as a granulated sugar product, or may an invert syrup. In further accordance with this and other aspects of the present disclosure, the low viscosity sucrose solution has a viscosity ranging from about 10 cPs to about 70 cPs.

In another aspect of the present disclosure, a process for manufacturing purified sucrose that is substantially free of inorganic impurities is described, wherein the process comprises obtaining an invert syrup sucrose-based material; contacting the invert syrup with water at a temperature and pH sufficient to dissolve the invert syrup and produce a low viscosity sucrose solution having not more than 76 wt. % solids; contacting the low viscosity sucrose solution with a first ion exchange resin bed in cation form by pumping the low viscosity sucrose solution through the first resin bed; contacting the low viscosity sucrose solution with a second ion exchange resin bed in anion form by pumping the low viscosity sucrose solution through the second resin bed; and spectroscopically analyzing the sucrose solution as it is eluted through the second resin bed, wherein the purified sucrose eluted from the ion exchange columns contains less than 5 ppm of each of the inorganic elements of Group 1, Group 2, Group 13, Group 14 and Group 15 of the Period Table of the Elements. In further accordance with this and other aspects of the present disclosure, the low viscosity sucrose solution has a viscosity ranging from about 10 cPs to about 70 cPs.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1 illustrates a general process flow diagram of an exemplary process of the present disclosure.

FIG. 2 illustrates a general process flow diagram of an additional exemplary process of the present disclosure.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DEFINITIONS

The following definitions are provided in order to aid those skilled in the art in understanding the detailed description of the present invention.

The term “sucrose”, or “sugar”, as used herein, means that compound having the general structure shown below, having the name α-D-glucopyranosyl-β-D-fructofuranoside (a disaccharide composed of D-glucosyl and D-fructosyl moieties), and the molecular formula C₁₂H₂₂O₁₁, as well as salts, hydrates, and stereoisomers (e.g., D,L or L, D) thereof.

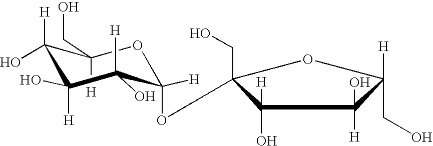

The term “invert sugar syrup”, as used herein, refers to those sucrose-based syrups (e.g., fructose and glucose) produced with the glycoside hydrolase enzyme invertase or an equivalent enzyme, or an appropriate acid, which splits each sucrose disaccharide molecule into its component glucose and fructose monomer molecules; one of each. The general reaction which produces “invert syrup” is shown below.

C₁₂H₂₂O₁₁ (sucrose)+H₂O (water)=C₆H₁₂O₆ (glucose)+C₆H₁₂O₆ (fructose)

The term “ash”, or “ash content”, as used herein, refers to the amount of inorganic impurities in sugar, whether it be raw sugar or a processes, purified, or refined sugar. It is typically given in percentages of the specific inorganic compound impurities, and can be determined by a number of methods, typically by conductivity methods and the like.

The phrase “free flowing powder”, or “free flowing powder composition”, as used herein, is meant to refer to a powder of which the particles consist of a composition containing a plurality of solid particles at or about ambient (about 25° C.) temperature, wherein the particles do not adhere to one another. This may be alternatively and equivalently referred to as an “adhesionless” powder mixture, wherein the particles can move around independently, absent ‘inter-particulate’ forces (see, for example, the discussion and description of such free-flowing powders in “Particle-Particle Adhesion in Pharmaceutical Powder Handling” by Fridrun Podczeck, Imperial College Press, 1998, section. 3.1.3., pp. 111-114, incorporated herein by reference).

The term “degrees Brix,” as used herein, (and as represented by the symbol ° Bx), is meant to refer to a unit of measurement used in the food industry for measuring the approximate amount of the dissolved sugar-to-water mass ratio of a liquid. It is typically measured with a saccharimeter that measures specific gravity of a liquid, or with a refractometer. For point of example, a 25° Bx solution is 25% (w/w), with 25 grams of sugar per 100 grams of solution. Or, to put it another way, there are 25 grams of sucrose sugar and 75 grams of water in the 100 grams of solution.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Applicants have created processes for the purification of refined sucrose into high-purity sucrose products which are substantially free of inorganic contaminants, sometimes referred to as “ash”, and discolorations. In a general sense, the process comprises obtaining an initial granulated sugar product, such as refined, raw sugar having an ash (inorganic) impurity level of about 0.05 wt. % or more, dissolving the granulated sugar product in water to form an aqueous sucrose solution having a dissolved solids content of not greater than about 50 wt. %, pumping the aqueous sucrose solution through a bed of cation exchange resin, pumping the eluent through a bed of anion exchange resin, analyzing the eluent using an appropriate analytical instrument, and then further processing or packing the purified, aqueous sucrose solution as desired.

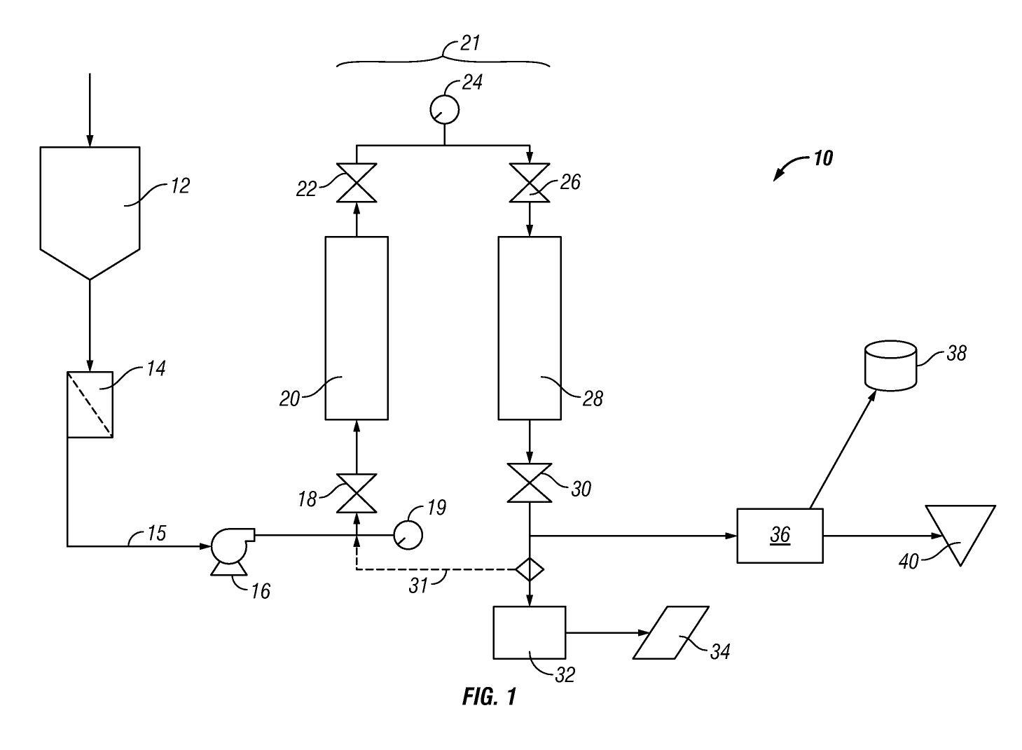

Turning now to the figures, FIG. 1 is an illustration of a flow diagram showing an exemplary purification process 10 according to a first embodiment of the present disclosure. Sucrose or a sucrose related product (e.g., fructose or glucose) starting material is obtained in refined or unrefined form, and is transferred to a kettle 12 or the equivalent, wherein it is admixed and diluted with water, preferably deionized water, to a dilute sucrose solution having a dissolved solids content ranging from about 20 wt. % to about 76 wt. %. In accordance with embodiments of the current disclosure, the dilute sucrose feed solution may have a dissolve solids content from about 20 wt. % to about 76 wt. %, including from about 25 wt. % to about 65 wt. %, and dissolved solids contents within these ranges, such as about 30 wt. %, about 40 wt. %, about 50 wt. %, and about 60 wt. % dissolved solids, without limitation. This dilute sucrose solution will preferably have a viscosity, as determined using standard viscosity-measurement methods and means, ranging from about 10 cP to about 70 cP, inclusive, including viscosities of about 20 cP, about 25 cP, about 30 cP, about 35 cP, about 40 cP, about 45 cP, about 50 cP, about 55 cP, about 60 cP, and about 65 cP, as well as ranges between any two of these values, for example, (and without limitation) from about 42 cP to about 62 cP. The source of the water used to dissolve the crystalline (or invert syrup) saccharides for use herein is not critical so long as it is potable, i.e. fit for human consumption. The temperature of the water for this dissolution step will typically be about ambient (about 25° C.), and generally should not exceed about 55° C., preferably not greater than about 40° C. The pH of the water for dissolution is not critical, however, and if the starting material is an invert syrup, the syrup pH should range from slightly acidic (e.g. about pH 3) to neutral (pH 7), typically in the range from about pH 3.5 to about pH 5.5. The dilute sucrose solution is then pumped through a filter means 14 having a sizing screen, or an equivalent pre-filtering means, so as to remove any particulate matter or for purpose of size exclusion, if appropriate. The filtered sucrose eluent stream 15 is then pumped via a typical process pump 16 or the equivalent to the multi-stage purification region 21 of the purification system of the present disclosure, which comprises one or more cation exchange resin beds and one or more anion exchange resin beds, arranged in series or in alternating configurations as appropriate. Further, while only one cation and anion resin bed are illustrated in the figure, it is to be understood that the process may comprise a plurality of each of such resin beds, as appropriate, such in large-scale plant purification process operations.

The sucrose used as the raw starting material for the processes disclosed herein may be refined or unrefined, as stated previously, or may be an invert syrup, and may be obtained from any number of sources, such as by extraction and milling, from sugarcane, sorghum, sugar maple, sugar beets, or from a combination of sources, such as from cane sugar and sugar beets. The starting material may also be regular table sugar, refined or unrefined, raw sugar (unrefined, crystalline sugar that is the product of a cane mill rather than a refinery), char liquor (a refinery process stream that has been treated with bone char to remove some of the impurities typically found in raw sugar during the refining process), clarified liquor, and other sugar refinery process streams from any point along the sugar refining process. In typical operations, and in accordance with the present disclosure, the raw starting material has a total ash (inorganic) impurity level of about 0.05 wt. % or more, as determined by spectroscopic analytical methods, and/or a color level ranging from about 2 RBU to about 30 RBU.

With continued reference to FIG. 1, the flow rate of the filtered eluent stream 15 is adjusted by adjusting the pump pressure, preferably to a eluent fluid flow rate ranging from about 0.10 gallons-per-minute (gpm) to about 0.50 gpm, more preferably from about 0.10 gpm to about 0.20 gpm, and even more preferably from about 0.12 gpm to about 0.18 gpm, inclusive. Those of skill in the art will realize, however, that the flow rate of the eluent will depend upon a number of factors, including the “length” of the purification system, the size and characteristics of the resin beds, and the valve and tubing size/diameters, among other considerations. Once the flow rate has been optimized as monitored by pressure indicator 19, the cation-exchange resin bed entry valve 18 is then opened, and the filtered eluent stream 15 is pumped onto and through cation exchange resin bed 20, which may be in a fixed bed, such as a column, or as part of a moving bed. The eluent stream 15 exits the cation exchange resin bed 20 through an exit port or valve 22, and is conveyed with continued pumping to anion-exchange resin bed 28 via valve 26. As the eluent stream 15 passes between the cation- and anion-exchange resin beds, the pressure of the flow stream is monitored, continually or randomly, by a pressure indicator 24 to ensure that the flow rate of the eluent stream is maintained within the target flow rate, e.g., between about 0.05 gpm and 0.20 gpm, wherein the pump rate is adjusted by adjusting the pump speed based on the pressure observed on the pressure indicators (19, 24). Exemplary flow rates suitable for use in accordance with the present disclosure may range from about 3.0 gallons per hour (gph) to about 20 gph, more preferably from about 3.5 gph to about 10 gph, although this range may expand depending upon the size of the purification operation. Consequently, in accordance with the present disclosure, it is preferred that the flow rate of the eluent streams through the resin beds is at a rate from 1 to 4, and more preferably from 1 to 2, bed volumes per hour, inclusive. The eluent stream 15 then passes through valve 26 and contacts anion-exchange resin bed 28 for a period of time sufficient to remove additional, unwanted inorganic impurities, the length of time for contact with the resin being a characteristic of the size of the resin bed, length of the column (if appropriate), and the like.

While the ion-exchange resin beds illustrated in the figures are shown as fixed-bed column systems, it is envisioned that the processes of the present disclosure may be carried out in other resin bed arrangements, including but not limited to contacting the eluent stream 15 with appropriately-activated moving beds, interlayered resin beds, mixed resin beds (a combination of anion and cation resins in various ratios as appropriate, e.g., 1:1, 1:2, or 2:1), packed bed systems, and the like. Additionally, while the process has been described with the use of cation and anion exchange resin beds, the process may also include the addition of, or the replacement of one or both resin beds, with one or more heavy-metal-selective chelating resin beds (such as those having EDTA or the equivalent as a functional group on the resin), as appropriate, in order to more effectively remove selected inorganic metals, such as mercury (Hg), copper (Cu), and lead (Pb). Further, the processes of the present disclosure may be performed, all or in part, at temperatures ranging from about 10° C. to temperatures of about 60° C. For example, in accordance with aspects of the presently disclosed process, the sucrose-containing eluent stream and the ion-exchange resin beds may be at a temperature ranging from about 10° C. to about 55° C., or more preferably from about 25° C. to about 55° C., during the purification process.

The cation exchange resin which can be used in the processes of the present disclosure is preferably a strong acid, cation exchange type polymeric resin having a mean particle size ranging from about 0.600 mm to about 0.900 mm, inclusive, such as from about 0.600 mm to about 0.850 mm. Exemplary cation exchange resins suitable for use with the presently described processes include but are not limited to AMBERLITE™ FPC22 H cation exchange resin (available from Rohm and Haas, Philadelphia, Pa.); DOWEX G-26(H) resin, DOWEX™ Monosphere 750C(H), DOWEX™ 88, DOWEX™ 88MB, DOWEX™ Monosphere 88, and DOWEX™ Marathon 650C (H) resins, and all available from The Dow Chemical Company (Midland, Mich.); and, DIAION® SK1B, SK104, SK110, SK112, SK1 16, PK208, PHK212, PK216 PK220, PK228 and DIAION® HPK25 strongly-acidic cation-exchange resins (all available from Mitsubishi Chemical); as well as numerous other similar, commercially-available cation exchange resins, preferably of the Na, Ca, or H-type, which is normally produced and sold in the Na— or Ca-form and is capable of being converted into the H-form by conditioning by contacting it with acid or an acid solution. In addition, the pH of the cation-exchange resin bed 20 during use in the present procedure is preferably in the pH ranging from about pH 1 to about pH 5, more preferably from about pH 1.5 to about pH 4.5, and even more preferably from about pH 2 to about pH 4, so as to adequately acidify the inorganics and make them more available to be removed. In addition, the contact of the sucrose-containing eluent stream with the low pH resin in resin bed 20 can advantageously result in the formation of “invert sucrose”, if so desired, having benefits as discussed above, including improved solubility characteristics in comparison with solid-form sucrose. The anion exchange resin which can be used in the processes of the present disclosure is preferably a base, anion exchange type polymeric resin, such as those of the Cl-form or similar form that can be converted to the OH— form for use in the process, having a mean particle size ranging from about 0.600 mm to about 0.900 mm, inclusive, such as from about 0.650 mm to about 0.820 mm. Exemplary anion resins suitable for use with the presently-described processes include but are not limited to AMBERLITE™ FPA42 Cl and AMBERLITE™ FPA90 Cl anion exchange resins (available from Rohm and Haas, Philadelphia, Pa.); Type I and Type II DOWEX brand anion resins (Cl form), such as DOWEX™ Marathon A LB, DOWEX™ UPCORE Mono A-625 resin, DOWEX™ SBR-P, DOWEX™ Marathon A2 resin, DOWEX™ 22 resin, DOWEX™ MSA-2 resin, and the like (all available from The Dow Chemical Company, Midland, Mich.), as well any resin which can be produced in an anion form, and which is capable of being converted to the OH-form prior to use in the instant process. The pH of the anion-exchange resin bed 28 during use in the present procedure is preferably in the pH ranging from about pH 5 to about pH 10, more preferably from about pH 5.5 to about pH 9.5, and even more preferably from about pH 5.5 to about pH 9, as well as pH ranges within these ranges, inclusive, such as from about pH 5 to about pH 8, or about pH 6 (in non-limiting example), so as to adequately acidify the inorganics and make them more available for removal.

Following exit from the anion-exchange resin bed 28, the purified eluent stream 29 passes through an exit valve 30, and an aliquot is sampled for its viscosity (as determined by, any number of appropriate methods, including the used of viscometers and other appropriate viscosity-measuring means, and determining the viscosity of the eluent stream at a given temperature using ° Bx), and tested in one or more analyzers 32 for target inorganic impurity levels, such test results 34 being generated in any suitable format, such as hard-copy, or electronically, or in association with a remote, online process system monitoring system, as suggested above. In accordance with aspects of the present disclosure, this eluent stream will preferably have a viscosity similar to that of the eluent prior to being contacted with the ion-exchange resin beds, e.g., from about 10 to about 70 cP. Thereafter, if it is determined that the sample has met the target purity requirements of being substantially free of inorganic impurities, the eluent is transferred to a finish processing facility 36, where it is transformed into a finished product in the desired state, as appropriate. If the target purity requirements as determined by the results of the analyzer 32 are undesirable (e.g., the inorganic element impurity level is too high), the eluent may be returned via return stream 31 to the purification process and re-directed through the cation and anion ion-exchange columns 20 and 28 one or more times, until the desired target purity is reached. Alternatively, the resin bed arrangement may comprise a plurality of both anion and cation resin beds (e.g., ion-exchange columns), in a variety of configurations, such as two cation beds and one anion bed in series, or one cation resin bed and two anion resin beds in series, or two of each type of ion-exchange resin beds, arranged with one of each arranged upstream and the other two arranged downstream, in alternate fashion (i.e., cation-anion-cation-anion). Consequently, in lieu of redirecting stream 31 to the initial cation bed 20, the stream 31 could be redirected to a fresh, downstream cation resin bed (not shown), so as to allow the initial upstream resin bed to be regenerated, as necessary.

In the event that the eluent stream comprising approximately 50 wt. % solids (or less) by volume has met the target purity level, it can be transferred at processing facility 36 in liquid form to a drum 38 (or the equivalent) and packaged for delivery in its dilute form. Alternatively, and equally acceptable, the purified eluent stream may be transferred to an evaporator or the like 40, wherein the liquid is evaporated off, de-watered, and/or filtered through a filtering media in order to generate a solid product having a low (less than about 5 wt. %) water content, such as less than or equal to about 2 wt. % water.

In accordance with at least one aspect of the present disclosure, the purified product stream is transferred to an evaporator 40 and a sufficient amount of water is evaporated to generate a final product having a final brix value ranging from about 60° Bx to about 80° Bx, including about 62° Bx, about 64° Bx, about 66° Bx, about 68° Bx, about 70° Bx, about 72° Bx, about 74° Bx, about 76° Bx, about 78°Bx, and 79° Bx, as well as values and ranges between any of these values, such as about 67° Bx, about 79° Bx, or ranging from about 65° Bx to about 75° Bx, without limitation. For example, if the product eluted off of the purifying resin bed system is a liquid, the brix will depend upon the composition of the eluent, with the maximum acceptable brix being determined by the solubility of the sucrose or sucrose mixture product. For example if the final product elute is substantially sucrose, the maximum brix may be about 67.5; if the final product elute is a medium invert, then the maximum brix may be about 79; and if it is a mixture of the two, the maximum brix of the eluent may be in the range between about 67.5 and about 79.

With regard to the sample analysis of the purified sucrose eluent following its passage through the ion-exchange columns, the analysis and purity monitoring is preferably done using spectroscopic methods, preferably ICP-MS (Inductively Coupled Plasma Mass Spectroscopy), alone or in combination with one or more additional analysis methods. ICP-MS is known in the art of analytical chemistry, and has been described, for example, in U.S. Pat. No. 6,265,717 B1, incorporated herein by reference. Other exemplary analytical methods suitable for analyzing the eluents from the process stream and determining the amount of desired inorganic ions in the purified sucrose include but are not limited to LA-ICPMS (Laser Ablation Inductively Coupled Plasma Mass Spectroscopy), ICP-OES (Inductively Coupled Plasma with Optical Emission Spectroscopy) set up for metals analysis, conductivity measurements of the sucrose solutions, fluorescence analysis (e.g., measuring sugar samples spectrofluorometrically); and, GFAA (Graphite Furnace Atomic Absorption) using Zeeman background correction, as well as combinations of these methods.

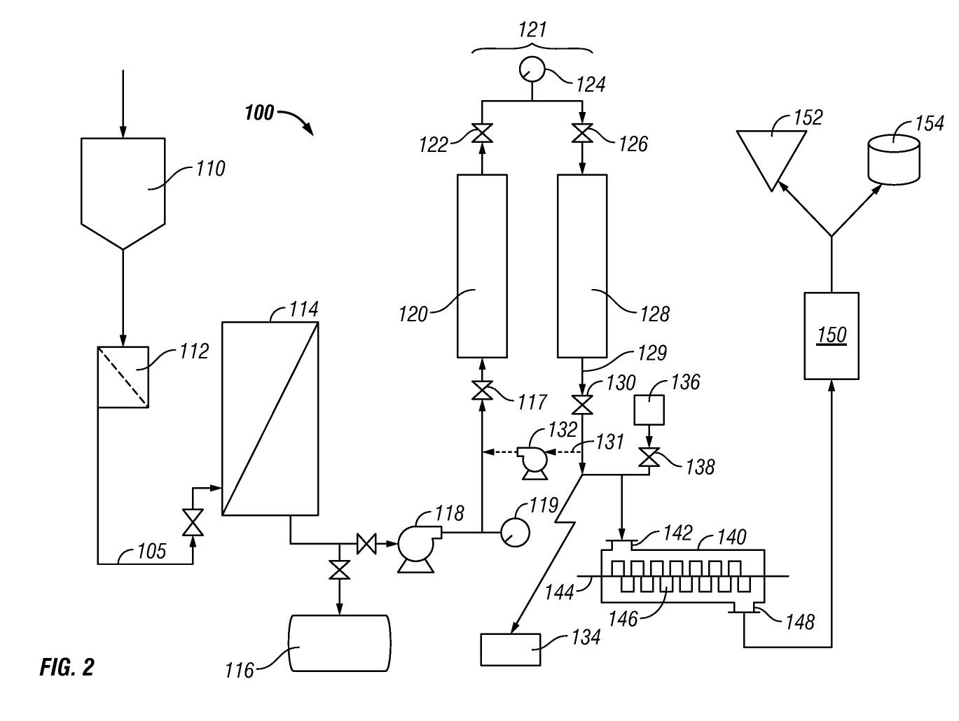

FIG. 2 illustrates an alternative process 100 in accordance with the present disclosure, using an adsorbent in combination with the ion-exchange purification process described in FIG. 1. Sucrose or a sucrose related product (e.g., fructose or glucose) starting material is obtained in refined or unrefined form (e.g., refined or raw sugar, or as an invert syrup), and is transferred to a kettle 110 or the equivalent, wherein it is admixed and diluted with water, preferably deionized water, to a dilute sucrose solution having a dissolved solids content ranging from about 20 wt. % to about 76 wt. %, and a viscosity ranging from about 10 cP to about 70 cP, as discussed previously herein. The dilute sucrose solution is then optionally pumped through a filter means 112 having a sizing screen, or an equivalent pre-filtering means, so as to remove any particulate matter or for purpose of size exclusion, if appropriate. The filtered sucrose eluent stream 105 is then pumped via a typical process pump to a liquid adsorption assembly 114, which may comprise single or multiple-pass filter media, and which may be contained within a housing as shown, which itself may be jacketed as appropriate for heating or cooling if appropriate. Therein, the eluent stream contacts one or more adsorption media for a period of time sufficient to remove an initial amount of inorganic impurities and/or color. Exemplary adsorption media suitable for use herein to effect the purification of the sucrose fluid stream are the ECOSORB® adsorbents (available from Grave Technologies, LLC, Glasgow, Del.), such as the ECOSORB® S products, and ECOSORB® 481, a combination of activated carbon and cation resin in the sodium form. After exiting the adsorbant assembly, the eluent stream may be diverted off to a separate holding tank 116 for direct use without any additional purification steps, or it may be directed by a pump assembly or the equivalent to the multi-stage purification region 21 of the purification system, which comprises one or more cation exchange resin beds and one or more anion exchange resin beds arranged in series, as discussed above with reference to FIG. 1.

Following exit from the anion-exchange resin bed 128, the purified eluent stream 129 passes through an exit valve 130, whereafter an aliquot is sampled for its viscosity (as determined by, any number of appropriate methods, including the use of viscometers and other viscosity-determining means, and determining the viscosity of the eluent stream at a given temperature using ° Bx), and tested in one or more analyzers 134 for target inorganic impurity levels, as suggested above with regard to the process of FIG. 1. Thereafter, if it is determined that the sample has met the target purity requirements of being substantially free of inorganic impurities, the eluent stream passes on to a crystallizer 140 is and converted to a free-flowing solid, as described below. Thereafter, the solid, free-flowing product may be transferred to a finish processing area 150, where it may be further processed as appropriate. If the target purity requirements as determined by the results of the analyzer 134 do not meet the target goals (e.g., less than about 5 ppm of each of the target inorganic elements to be removed), the eluent may be returned via return stream 131 and associated pump 132 to the purification process and/or re-directed through additional cation and anion ion-exchange resin beds as appropriate, until the desired target purity is reached.

When the purified eluent stream is passed to a high intensity mixer/crystallizer 140, it may be optionally combined with additional high-purity reserve product, such a very high purity invert syrup or a high purity sucrose product 136 via valve 138 prior to or simultaneous with entry into the mixing reactor 140. High intensity mixer 140 may be any suitable mixer, such as a “Bepex Turbulizer”, a high-intensity mixing reactor (available from Hosokawa Bepex GmbH, Leingarten, Germany), such as a paddle-type high-intensity mixer having a plurality of paddle-type blades 146 mounted on a rotatable shaft 144, and which may be jacketed or not as appropriate, in order to allow heat (such as from steam) to be applied. The eluent stream 129 is introduced into the mixer 140 via entry port 142 at appropriate mass flow rates determined by the size of the manufacturing run, typically up to about 1000-30000 pounds/hr per square foot of cross sectional mixer area or more, and the paddle-type blades 146 may be effectively operated at tip speeds of up to about 20-40 feet/second or more. The residence time of the stream in the mixer 140 may be controlled by a number of factors, including the pitch of the blades 146. In addition, the pitch may be varied so that, e.g., the upstream blades 146 advance the solids while the downstream blades 12 mix the solids and the solution together. Other high intensity conditions or other high intensity mixers which effectively wet and homogenize the reaction products and (at least for a continuous process) scrape the mixer walls may be alternatively employed. In contacting the purified sucrose product with a high-intensity mixer 140, the product stream may exit the outlet nozzle 148 of the mixer as a free-flowing powder material, which may then be readily conveyed by any appropriate means (e.g., a screw conveyer or the like) to finishing region 150 for any additional further process as desired, and thereafter packed into a drum 154 (or the equivalent), or a tote 152.

In further accordance with the present disclosure, the process may comprise producing a very high purity sucrose and high purity invert syrup product separately, starting from an invert syrup starting material. Thereafter, the high purity products can be stored and shipped separately, or they may be optionally combined in a crystallizer, such as a Hosakowa Bepex Turbulizer/impact mixer (e.g., the Flexomix) (Hosokawa Bepex GmbH, Leingarten, Germany), as discussed above with reference to FIG. 2. Following such crystallization process, the product obtained is preferably a free-flowing powder.

The processes of the present disclosure may further comprise a decolorization step, using any appropriate decolorization means, such as filters, resins, absorption technology, and the like, wherein the sucrose-containing fluid stream is contacted with one or more decolorization means for a time appropriate to remove undesirable compounds which adversely affect the overall appearance of the final sucrose product. The term “decolorization” refers to the removal of color, flavor, odor, or UV compounds or combinations thereof from a sugar solution during the production process. Color compounds can include, but are not limited to, (1) caramels, (2) melanoidins, and (3) polyphenolics and flavanoids. The caramels are thermal degradation products of sugars. Melanoidins are, in general, non-enzymatic color-forming reaction products of amine compounds (such as amino acids) and phenols with reducing sugars, often referred to as Maillard products. Polyphenolics and flavanoids are oxidation products of phenolic compounds derived from a raw sugar solution, and include at least a dozen catecholamines which have been reportedly separated from the raw juice of sugar [Winstrøm-Olsen, B., et al., International Sugar Journal, Vol. 81 (971), pp. 332-336; pp. 362-368 (1979)]. In addition to the three classes of color bodies, there are several noncolored compounds that can develop color or can react to form color bodies during processing or storage of sugar solutions. Such materials are known as color precursors, and for the purpose of describing this invention, the term “color bodies” is intended to include such color precursors. These precursors include amino acids, hydroxy acids, aldehydes, iron compounds which complex with phenolics, 5-hydroxymethyl-2-furfural, 3-deoxy-d-glucose, and reducing sugars. As used herein, the term “UV compounds” refers to a class of compounds that absorb ultra violet light in a spectrophotometer. In certain applications, the presence of these compounds is undesired. Therefore, the UV compounds are desirably removed from the sugar solution at least in the decolorization step.

The purified sucrose products resultant from the processes disclosed herein are substantially free of inorganic impurities. As used herein, the phrase “substantially free of inorganic impurities” means that the purified sucrose product, after having been purified using one or more of the processes disclosed herein, contains less than about 50 ppm total inorganic elements, preferably less than about 10 ppm total inorganic elements, preferably less than about 5 ppm total inorganic elements, and more preferably less than about 1 ppm inorganic elements. The inorganic elements may be any of those elements of the periodic table which are typically classified as “inorganic” as described by Cotton & Wilkinson in “Advanced Organic Chemistry, 6^{th} Ed.” (John Wiley & Sons, Inc.; 1999), and which includes alkaline earth metals, and transition metals/transition elements (particularly those of first, second and third transition series), and as described in the Period Table and associated IUPAC Technical Report published in Pure Appl. Chem., Vol. 78(11), pp. 2051-2066 (2006). In accordance with one non-limiting aspect of the present disclosure, the purified sucrose product which is substantially free of inorganic impurities has less than about 5 ppm, preferably less than about 2 ppm of each of the Group 1, Group 2 (Group IIA), Group 13, Group 14, Group 15 and Group 16 elements (Groups IIIA, IVA, VA and VIA) of the periodic table. For example, and without limitation, in accordance with the presently described processes, the purified sucrose products preferably comprise ≦about 3 ppm, more preferably comprise ≦about 1.0 ppm, and most preferably comprise ≦about 0.1 ppm each of the elements Na, K, Mg, Ca, Sr, Ba, B, Al, Ga, In, TI, Si, Ge, Sn, Pb, P, As, Sb, Bi, Se, Te and Po. In accordance with a further aspect of the present disclosure, the purified sucrose product which is substantially free of inorganic impurities contains less than about 3.0 ppm, more preferably less than about 2.0 ppm of at least phosphorus (P), aluminum (Al), and boron (B), and even more preferably less than or equal to (≦) about 0.1 ppm Al, ≦0.05 ppm B, and ≦0.05 ppm P.

In further accordance with the present disclosure, the purified sucrose products produced by the processes disclosed herein have a color after purification of less than about 46 RBU ICUMSA (International Commission for Uniform Methods of Sugar Analysis), which is a standard measure of color in the sugar industry, wherein color is determined using photometric methods for the colorimetric measurement of filtered sugar suspensions. The transmission of the sample is measured at specific sugar concentrations (Brix values), as the absorption at 420 nm (for white sugar, 560 nm for dark sugar) of a membrane-filtered solution of sugar adjusted to pH 7, and the color is given as a unit (RBU, as defined by McGinnis in Sugar Technology Reviews, Vol. 11, p. 14 (1984)) derived from the absorbance where 45 RBU is the maximum allowed color of standard sugar).

While the process described herein is understood to be capable of being carried out in the standard practices of a chemical product production or manufacturing facility, it is envisioned that this process may also be carried out manually by one or more operators, or alternatively, may be controlled by a remote, online production process monitoring system, using real-time or near-real time monitoring, such as described by MacGregor and co-workers [Chemometrics Intel. Lab. Systems, Vol. 51 (1); pp. 125-137 (2000)], and in U.S. Pat. No. 6,607,577, wherein a computer system continuously or randomly (e.g., in a pre-programmed or determined manner) monitors a plurality of the valving, pump flow rates, eluent concentration, and the like in real-time or in “near-real-time”, reports it to a remotely located operator, who then makes adjustments and corrections to the system as appropriate, in order to facilitate optimal operation of the production stream.

The purified sucrose and sucrose-based products (e.g., fructose and/or glucose) resultant from the processes described herein may be used in a variety of applications, in addition to their use in the general food industry. For example, and without limitation, the high purity sucrose and associated products having substantially no inorganic contaminants may be used in ‘ultra-pure’ food products, such as high-end confections; as high-purity (e.g., greater than 99% purity) chemical reagents; in the preparation of polymers, such as rigid polyurethane foams; in the preparation of plasticizers, such as in the addition to gelatin in the manufacture of plasticizers having specific mechanical properties and water vapor permeability (WVP); in the plastics and cellulose industry; in the manufacture of hydrocolloids; in the manufacture of ink products; in the manufacture of soaps, particularly transparent soap products; as starting materials in the fermentative production of ethanol, butanol, glyceraol, citric acid, and luvelinic acid; in the manufacture of cosmetics, such as, for example, in the use of sucrose or sucrose derivatives in or for making topical compositions for a variety of cosmetic applications, including the promotion of skin exfoliation, in controlling intrinsic and extrinsic skin ageing, as well as a non-therapeutic skin treatment methods for skin exfoliation; in the arena of high-purity metals and metal manufacture; as a source of high-grade carbon for use in electronics manufacture; in the formulation of neutraceuticals; in the manufacture of batteries, such as Lithium-ion batteries; in pesticide formulations, such as in the manufacture of sucrose octanoate and sucrose octanoate esters for control of mites (e.g., Varroa mites on adult honey bees) and various soft-bodied insects which are harmful to both food and non-food crops (e.g., tobacco), including aphids, caterpillars, and glassy-winged sharpshooters; and, in pharmaceuticals and pharmaceutical formulations. With regard to the latter of these potential applications, pharmaceuticals, it is envisioned that the high-purity sucrose which results from the processes described herein could be used both in the manufacture of the active-ingredient of pharmaceuticals, such as cholestyramine-sucrose and VENOFER® (polynuclear iron (III)-hydroxide in sucrose for intravenous injection), an iron-sucrose injection for use in the treatment of iron deficiency anemia in patients undergoing chronic hemodialysis who are receiving supplemental erythropoietin therapy; and, in the formulation of pharmaceuticals (and nutraceuticals), such as in coatings for tablets, sucrose-based diluents and binders, in syrups, and as sucrose-based compressible sugars used in controlled-release formulations and standard tablet and pill formulations.

The following examples are included to demonstrate preferred embodiments of the invention. It should be appreciated by those of skill in the art that the techniques disclosed in the examples which follow represent techniques discovered by the inventor(s) to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

### Example 1

### Preparation of Samples

Four feed-stream sugar products for use in the process were obtained from a variety of sources, and were diluted with water (SugarLand, Tex., tapwater or deionized water) to a feed stream concentration of about 50 wt. % solids (±5 wt. %). In a typical procedure, approximately 725 lbs of the raw feed-stream sugar product was prepared by weighing the granulated sugar product into a plastic pail or appropriate container, and then diluting/dissolving the granulated sugar (with stirring) to the appropriate solids concentration (e.g., 50% solids) and viscosity using water. Once dissolution had been achieved, the feed stream products for the purification process were transferred to a feedtank that was in fluid communication with the purification plant assembly generally illustrated in FIG. 1. Exemplary ICPMS data for the starting feedstock used in the example—granulated sugar, char liquor, liquid sucrose, and medium sucrose invert fluid—are presented in Table 1, although any number of feedstocks could be used, including char liquor, liquid sucrose, and medium sucrose invert fluid, without limitation.

TABLE 1
Selected inorganic element impurity amounts of starting feedstreams.¹

| Feed Source | P (ppm) | Al (ppm) | B (ppm) |
|---|---|---|---|
| Refined sugar (sugar cane) | 0.21 | 0.11 | ND |
| | ND² | 0.258 | ND |
| Average | 0.21 | 0.184 | — |

¹Inorganic element analysis conducted by Inductively Coupled Plasma-Mass Spectrometry, performed on a PerkinElmer ICP-MS by Pace Analytical Services, Inc., St. Rose, LA, and the results reported in compliance with the 2003 NELAC standards. The analyses were measured twice, as shown in the table.
²“ND” denotes ‘Not Detected’ at or above the reporting limit or PQL, indicating that any of the element being tested for, if present in the sample, was at a level lower than the detection limits for the method and/or the instrument used.

The purification system, and in particular the ion-exchange columns, were then prepared as follows. The entire system, which included a cation-form ion-exchange resin assembly and an anion-form ion-exchange resin assembly, were initially rinsed with water (deionized water) by pumping a volume of water through the entire system once at a high pumping rate, prior to charging the ion-exchange resins with resin. Once the system is full of deionized water, and is discharging water at the tail end, adjust the pump setting such that the fluid flow rate through the entire system is in the range from about 0.05 gpm (gallons per minute) to about 0.20 gpm. At this point, with water flowing through the system, 15 liters (equivalent) of both the cation and anion exchange resins are weighed out. Approximately 3.5 gallons of the AMBERLITE™ FPC22 H cation resin (Rohm & Haas, Philadelphia, Pa.) is charged to a 5 gallon pail, rinsed with water, and drained. This process is repeated two more times. The rinse FPC22 H cation resin is then transferred to the cation exchange column for use in the purification system, rinsed with water until the eluent ran clear, and the bottom valve on the column is closed. The column is filled with water, and the top valve is closed, sealing the resin in the column, whereafter the cation exchange bed is installed in the purification system. In a similar manner, for the anion exchange column, a 20-25 gallon solution of 4-5 wt. % NaOH in water is prepared. The anion exchange resin, AMBERLITE™ FPA90 Cl anion exchange resin is rinsed with deionized water, similar to the manner in which the cation exchange resin was rinsed, and the resin was then washed with the dilute NaOH solution, and the resin allowed to swell. Following three more rinses with water, the rinsed FPA90 Cl resins was transferred to the anion exchange column, the resin rinsed with water until the eluent discharge from the column had a conductivity of <20 uS/cm, the bottom and top valves of the column were closed off, and the anion exchange bed was installed in the purification system.

The purification system was then filled with deionized water up to the bottom of the cation-exchange resin column, and the valves at the bottom and top of the column were opened. Water (deionized) was continually added to the anion exchange column in a similar manner, until the entire system was full, and equilibrated, whereafter the final discharge valve in the system was opened briefly and the flow rate of fluid through the system was confirmed to be between 0.05 gpm and 0.20 gpm.

### Example 2

### Plant Purification Procedure

To the feed stream product prepared as described above was inserted a pump inlet tube, the pump and pump controller were turned on and adjusted to a flow rate between about 0.05 gpm and 0.20 gpm, and the valves of the purification system were opened, from the final discharge valve to the inlet valve for the cation exchange inlet, adjusting and monitoring system pressure as appropriate. At this point, the pump transfers the feed stream product through an optionally-included filter assembly with a sizing screen to ensure solution particle size and remove any large fines that may be present, after which the feed-stream is transferred to the inlet of the cation exchange column. As the solution continues to move through the system, the discharge valve to the system was monitored hourly and a degree brix determination is made to monitor the displacement of water in the system by the feed-stream solution. When the discharge had a value of about 20 brix, the “sweetening-on” water (having <20 brix) was collected and labeled as Feedstream A Sweeting-On Water.

When the brix value of the discharge from the system reached a consistent value of from about 40-50 brix, indicating that the process of “sweeting on” was complete, all the material collected having a brix value between about 20 brix and about 50 brix was set aside in a separate lot and labeled as Feedstream A Start-Up. With regard to this part of the procedure, the preferred practice is to pump in the sugar solution until all of the water in the resin bed has been displaced, as confirmed by obtaining a discharge material having a consistent 40-50 brix value. The pH and conductivity of the sample was measured and recorded. Purified product collection was then begin, and the primary product streams were collected in a collection tank, and were sampled every 30 minutes, checking for degree brix (preferably between 40 and 50 brix), conductivity, and pH, as well as inorganic impurity concentration using ICP-MS. When all of the initial feedstream had been fed into the system, an additional 15 gallons of deionized water was used to rinse the feedstream storage tank, and that rinse fluid was similarly pumped through the purification system.

Upon obtaining an analysis of purified fluid stream having a brix value below 40, primary product collection was stopped, and the feedstreams having a brix value between about 20 and 40 brix were collected into a separate collection vessel. Once the brix value of the discharge stream from the system was consistently below about 20 brix, the system was stopped. The purified stream product was analyzed for inorganic impurities, in particular aluminum (Al), boron (B), and phosphorus (P), using Inductively Coupled Plasma-Mass Spectrometry. The values of these inorganic impurities that are desirable to minimize in sucrose products following this purification procedure, are given in Table 2. If the levels of all three of these inorganic ions in the purified sample were separately and individually less than about 1 ppm (average value after duplicate analysis), the purified product was evaporated to a final product having a net weight of about 600 lbs. and a brix value of about 67 brix. If the levels of individual inorganic elemental impurities, in particular Al, B, and/or P, were individually greater than about 1 ppm, the product was run through the purification system one more time, or alternatively, was combined with the feedstream cuts having brix values between about 20 and 40 brix and then passed through the system again.

TABLE 2
Selected inorganic elemental impurity levels of sucrose product, post
purification process.¹

| Run | Sample | Al (ppm) | B (ppm) | P (ppm) |
|---|---|---|---|---|
| A | 3 | 0.02 | ND² | ND |
| | 5 | 0.04 | ND | ND |
| | 6 | 0.03 | 1.2* | ND |

| | | | |
|---|---|---|---|
| Average: | 0.03 | 1.2 | — |

| | | | | |
|---|---|---|---|---|
| B | 3 | 0.08 | ND | ND |
| | 5 | 0.04 | ND | ND |
| | 6 | 0.05 | ND | ND |

| | | | |
|---|---|---|---|
| Average: | 0.05 | — | — |

¹Inorganic element analysis conducted by Inductively Coupled Plasma-Mass Spectrometry, performed on a PerkinElmer ICP-MS by Pace Analytical Services, Inc., St. Rose, LA, and the results reported in compliance with the 2003 NELAC standards. The analyses were measured twice, as shown in the table.
²“ND” denotes ‘Not Detected’ at or above the reporting limit or PQL, indicating that any of the element being tested for, if present in the sample, was at a level lower than the detection limits for the method and/or the instrument used.
*Apparent erroneous data point.

Other and further embodiments utilizing one or more aspects of the inventions described above can be devised without departing from the spirit of Applicant's inventions. For example, the resin bed arrangements can be changed, such that the beds are fed top down instead of bottom up as illustrated herein, the cation and anion resin beds could be decoupled by placing a surge tank or the equivalent in between, and the number and order of the resin beds can be varied, such as cation-anion-cation, anion-cation, cation-cation-anion-anion, and the like. Additionally, it is envisioned that different solids levels could be run, and different run rates could be applied, depending on what the composition of the starting feed is, how heavily loaded it is, and the efficiency of the purification process. For example, and without limitation, lower solids and slower rates may be more effective at inorganic impurity removal, but less efficient in terms of rate of throughput. Additionally, if the feed stream has a substantially low total inorganic element impurity level at the start of the process (e.g., less than about 5 ppm), then the processes of the present disclosure can be run at the higher end of the solids levels and/or the flow rate ranges contemplated and disclosed herein. Further, the various methods and embodiments of the purification processes for the production of highly pure sucrose which is substantially free of inorganic impurities can be included in combination with each other to produce variations of the disclosed methods and embodiments, e.g., elements may be re-arranged, orders may be changed or done multiple times, and process elements and steps may be combined if appropriate. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A process for manufacturing purified sucrose, the process comprising:
obtaining raw sugar;
refining the raw sugar to produce a refined sucrose product;
contacting the granulated sucrose product with water at a temperature sufficient to dissolve the refined sucrose product and produce a low viscosity sucrose solution having not more than about 76 wt. % solids;
contacting the low viscosity sucrose solution with a first ion exchange resin; and
contacting the low viscosity sucrose solution with a second ion exchange resin;
wherein the purified sucrose eluted from the ion exchange columns is substantially free of inorganic impurities, and has a color of 46 RBU or less.

2. The process of claim 1, wherein the refined sucrose product is an invert syrup.

3. The process of claim 1, wherein the refined sucrose product is a solid.

4. The process of claim 1, wherein the water used to dissolve the refined sucrose product is at a temperature ranging from about 5° C. to about 65° C.

5. The process of claim 1, wherein the low viscosity sucrose solution has a viscosity ranging from about 10 cPs to about 70 cPs.

6. The process of claim 1, wherein the first ion exchange resin is a cation exchange resin.

7. The process of claim 1, wherein the second ion exchange resin is an anion exchange resin.

8. A process for manufacturing purified sucrose, the process comprising:
obtaining raw sugar;
refining the raw sugar to produce a refined sucrose product;
contacting the refined sucrose product with water at a temperature sufficient to dissolve the refined sucrose and produce a low viscosity sucrose solution having not more than 76 wt. % solids;
contacting the low viscosity sucrose solution with a first ion exchange resin bed in cation form by pumping the low viscosity sucrose solution through the first resin bed;
contacting the low viscosity sucrose solution with a second ion exchange resin bed in anion form by pumping the low viscosity sucrose solution through the second resin bed; and
spectroscopically analyzing the sucrose solution as it is eluted through the second resin bed,
wherein the purified sucrose eluted from the ion exchange columns contains less than 0.1 ppm Aluminum, less than 0.1 ppm Boron, and less than 0.1 ppm Phosphorus.

9. The process of claim 8, wherein the low viscosity sucrose solution is eluted through the first and second resin beds at a fluid flow rate between about 0.05 gpm and about 0.20 gpm.

10. The process of claim 8, wherein the spectroscopic analysis is performed using inductively coupled plasma mass spectroscopy.

11. A process for manufacturing purified sucrose that is substantially free of inorganic impurities, the process comprising:
obtaining an invert syrup sucrose-based material;
contacting the invert syrup with water at a temperature and pH sufficient to dissolve the invert syrup and produce a low viscosity sucrose solution having not more than 76 wt. % solids;
contacting the low viscosity sucrose solution with a first ion exchange resin bed in cation form by pumping the low viscosity sucrose solution through the first resin bed;
contacting the low viscosity sucrose solution with a second ion exchange resin bed in anion form by pumping the low viscosity sucrose solution through the second resin bed; and
spectroscopically analyzing the sucrose solution as it is eluted through the second resin bed,
wherein the purified sucrose eluted from the ion exchange columns contains less than 5 ppm of each of the inorganic elements of Group 1, Group 2, Group 13, Group 14 and Group 15 of the Period Table of the Elements.

12. The process of claim 11, wherein the purified sucrose contains less than about 0.1 ppm of Mg, less than about 0.1 ppm of Al, less than about 0.1 ppm of B, less than about 0.1 ppm Ga, less than about 0.1 ppm P, less than about 2 ppm Na, and less than about 0.1 ppm As.

13. The process of claim 12, wherein the purified sucrose product comprises less than about 0.1 ppm Al, less than about 0.05 ppm B, and less than about 0.05 ppm P.

14. A purified sucrose product as prepared according to the process of claims 1.

15. A product comprising the purified sucrose product of claim 1, wherein the product is a cosmetic, a bulk chemical product, a neutraceutical, a pesticide, or a binder for manufacturing pharmaceutical tablets.
